(19) United States
(12) Patent Application Publication
(10) Pub. No.: US 2010/0237536 A1
(43) Pub. Date: Sep. 23, 2010

(54) MOLD FOR IN-MOLD COATING AND IN-MOLD COATING METHOD

(75) Inventors: Susumu HORINAKA, Tochigi (JP); Masato NOGUCHI, Tochigi (JP); Tomohiko SHIGIHARA, Tochigi (JP); Yasuki OKANEMASA, Tochigi (JP); Hidekazu KABAYA, Tochigi (JP); Ayato UEHA, Tochigi (JP); Yasuhiko TANGE, Tochigi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/720,388

(22) Filed: Mar. 9, 2010

(30) Foreign Application Priority Data
Mar. 23, 2009 (JP) 2009-069302
Mar. 24, 2009 (JP) 2009-071101
Mar. 25, 2009 (JP) 2009-073150
Mar. 27, 2009 (JP) 2009-079921

(51) Int. Cl. B29C 45/14

(52) U.S. Cl. 264/255; 425/542

(57) ABSTRACT

A mold for in-mold coating is provided that can ensure a space through which a coating material for performing in-mold coating flows. The mold for in-mold coating includes an undercut-shaped recess 15 formed of a wall portion 15a provided in a mold opening direction and an inclined wall portion 15b provided to face the wall portion 15a at a predetermined angle α2 in a region corresponding to an end or a corner portion of a product.

### BACKGROUND OF THE INVENTION

1. Field of the Invention

The present invention relates to a mold for performing in-mold coating, and an in-mold coating method for injecting a coating material into a mold in parallel with resin molding and coating a front surface of a resin molded product with the coating material.

2. Description of the Related Art

A multi-cavity mold has been conventionally known in which a runner is connected to each of a plurality of cavities and a recess is formed in a surface forming the runner, except a surface on which a coating material flows (for example, see Japanese Patent Laid-Open No. 2006-289794). Forming such a recess delays hardening of melted resin in the recess, and can prevent tension from acting on a resin molded product molded by the cavity. Since the tension acting on the resin molded product molded by the cavity is prevented, a resin molded product rising surface portion molded by a rising surface portion of the cavity is not deformed by shrinkage due to molding.

A mold is also known in which a recess is provided in a runner to prevent a film material from flowing into a melted resin injection portion (for example, see Japanese Patent No. 3599441). Providing such a recess in the runner defines a shrinkage direction of resin toward the mold, eliminates a gap between the resin and the mold, and prevents the film material from flowing into the melted resin injection portion.

A mold is also known in which an auxiliary cavity is provided communicating with a main cavity formed by a fixed mold and a movable mold, a film material injection portion for injecting a film material into an interface between resin injected into the main cavity and a mold surface of the main cavity or a space formed between the resin injected into the main cavity and the mold surface of the main cavity is provided in a middle region of the auxiliary cavity, and a groove that prevents the film material from flowing out is provided in a mold surface on the side where the film material is injected in an end region of the auxiliary cavity (for example, see Japanese Patent Laid-Open No. 8-309789).

Further, a conventional in-mold coating method is known including, to coat a front surface of a resin molded product with a coating material, a step of injecting the coating material at multiple variable speeds with a desired injection speed pattern into an interface between an in-mold front surface and a resin molded product and coating the front surface of the resin molded product, with the mold held as it is at the time of proper curing or hardening such that the front surface of the resin molded product can resist injection and flow pressure of the coating material, and a step of curing the coating material (for example, see Japanese Patent Laid-Open No. 6-328504).

However, the technique described in Japanese Patent Laid-Open No. 2006-289794 may act on shrinkage in a longitudinal direction, but shrinkage (in a vertical direction) of the rising surface portion itself cannot be accommodated. As a result, a corner portion of the resin molded product adheres to the cavity, causing poor filling of the coating material.

In the technique described in Japanese Patent No. 3599441, the resin does not only shrink in vertical and horizontal directions, but also shrink in a direction of preventing adhesion between the mold and the resin. Thus, a gap is created between the mold and the resin, and the film material cannot be completely prevented from flowing into the melted resin injection portion.

In the technique described in Japanese Patent Laid-Open No. 8-309789, the groove that prevents the film material from flowing out is provided, but leakage of the film material cannot be sufficiently prevented due to shrinkage of the resin in the groove and injection pressure of the film material.

Further, in the technique described in Japanese Patent Laid-Open No. 6-328504, curing of the resin molded product is a condition for the coating material injection, which requires a curing time of resin and increases a cycle time for injecting the coating material after curing of the resin. Also, since a predetermined amount of coating material is supplied, variations in shrinkage of the resin cannot be accommodated or sufficient adherence cannot be obtained, which may cause poor molding.

The present invention is achieved in view of such problems of the conventional techniques, and has an object to provide a mold for in-mold coating that can ensure a space through which a coating material flows, prevent the coating material from flowing over a runner into a sprue, and prevent the coating material from flowing out toward a back surface of a resin product in performing in-mold coating, and an in-mold coating method that can improve adherence between the coating material and the resin molded product without any special facility and mold.

### SUMMARY OF THE INVENTION

To achieve the above-described object, the invention according to claim 1 provides a mold for in-mold coating including an undercut-shaped recess formed of a wall portion provided in a mold opening direction and an inclined wall portion provided to face the wall portion at a predetermined angle in a region corresponding to an end or a corner portion of a product.

An angle α2 formed by the wall portion and the inclined wall portion is desirably equal to or larger than an angle β2 formed by the wall portion and a product surface of a vertical wall (α2≧β2).

The invention according to claim 3 provides a mold for in-mold coating in which a cavity is formed by a fixed mold and a movable mold, melted resin is injected into the cavity to mold a resin product, and the resin product is coated, wherein a protrusion is provided on a runner through which the melted resin passes, and shrinking resin adheres to the protrusion to form a seal portion.

It is desirable that the protrusion forms a protruding shape with two continuous inclined surfaces, and an angle α formed by the inclined surface and a flowing direction of the melted resin is desirably 30°≦α≦60°.

The invention according to claim 5 provides a mold for in-mold coating in which a cavity is formed by a mold on a front surface side of a resin product and a mold on a back surface side of the resin product, melted resin is injected into the cavity to mold the resin product, and a front surface of the resin product is coated with a coating material, wherein a recess is provided in a peripheral edge of the mold on the back surface side of the resin product that forms the cavity facing an injection portion of the coating material, resin that is molded by the recess and the cavity and shrinks adheres to the mold on the back surface side of the resin product and the mold on the front surface side of the resin product to form a seal portion of the coating material flowing out toward the back surface of the resin product.

A relationship between a depth t2 of the recess and a depth t1 of the cavity adjacent to the recess is desirably 0.01t1≦t2≦t1.

Further, the invention according to claim 7 provides an in-mold coating method for injecting a coating material into a mold and coating a front surface of a resin molded product, including an injection step of injecting the coating material into the mold; and a pressure maintaining injection step of injecting the coating material into the mold so that pressure in the mold obtained in the injection step is maintained at a predetermined value or more.

In the in-mold coating method according to claim 7, the injection step may be a fixed amount injection step of injecting a predetermined amount of coating material into the mold, or may be a fixed pressure injection step of injecting the coating material into the mold until pressure in the mold reaches a set pressure.

The invention according to claim 10 provides an in-mold coating method for injecting a coating material into a mold and coating a front surface of a resin molded product, including an injection step of injecting the coating material into the mold; and a pressure maintaining injection step of injecting the coating material into the mold so that injection pressure of a coating material supply device obtained in the injection step is maintained at a predetermined value or more.

In the in-mold coating method according to claim 10, the injection step may be a fixed amount injection step of injecting a predetermined amount of coating material into the mold, or may be a fixed pressure injection step of injecting the coating material into the mold until injection pressure of the coating material supply device reaches a set pressure.

With the invention according to claim 1, the resin product can be caused to shrink in a desired direction, and a gap through which the coating material flows can be ensured between the resin product and the cavity even with a complex product shape. The gap through which the coating material flows can be ensured to fill the coating material, thereby obtaining a sufficient film thickness on the front surface of the resin product.

Setting the angle α2 to a proper angle can reliably form the gap through which the coating material flows between the resin product and the cavity.

With the invention according to claim 3, the resin has a large volume and significantly shrinks in the runner portion, and an adhesive force of the resin to the protrusion provided on the runner is increased to form a seal portion with high sealability, thereby preventing the coating material from flowing over the runner into the sprue. Also, the mold can be easily machined, thereby reducing costs.

Setting the angle α to a proper angle (30°≦α≦60° increases the adhesive force of the resin to the protrusion provided on the runner.

With the invention according to claim 5, even around the injection portion of the coating material with high injection pressure, adherence between the shrinking resin and the mold can be maintained to prevent the coating material from flowing out toward the back surface of the resin product. Since the coating material does not flow into an unnecessary region, there is no shortage of the coating material at an end portion of the resin product.

Setting the relationship between the depth t2 of the recess and the depth t1 of the cavity adjacent to the recess to 0.01t1≦t2≦t1 allows an adhesive force to the mold on the back surface side of the resin product and the mold on the front surface side of the resin product by the shrinking resin to be obtained.

With the invention according to claims 7 to 12, adherence between the coating material and the resin molded product can be improved without any special facility and mold. Shrinkage of the resin and shrinkage of the coating material itself can be accommodated, thereby eliminating a flaw such as a sink and significantly improving quality.

### BRIEF DESCRIPTION OF THE DRAWINGS

FIG. 1 illustrates a resin product, FIG. 1(A) is a perspective view, FIG. 1(B) is a sectional view taken along the line A-A, and FIG. 1(C) is a sectional view of the resin product coated with a coating material;

FIG. 2 schematically illustrates in-mold coating;

FIG. 3 is an enlarged view of an anchor portion;

FIG. 4 is an enlarged view of essential parts of the resin product;

FIG. 5 illustrates an operation;

FIG. 6 illustrates a mold for in-mold coating according to the present invention, FIG. 6(A) is a sectional view, FIG. 6(B) is an enlarged sectional view of essential parts;

FIG. 7 is a sectional view of a product molded by the mold for in-mold coating according to the present invention;

FIG. 8 is a sectional view of the mold for in-mold coating according to the present invention;

FIG. 9 is an enlarged sectional view of a protrusion;

FIG. 10 is an enlarged sectional view of a protrusion in another embodiment;

FIG. 11 illustrates the in-mold coating;

FIG. 12 illustrates the in-mold coating;

FIG. 13 illustrates an operation of the protrusion;

FIG. 14 illustrates an operation of the protrusion, FIG. 14(A) shows a case of 30°≦α≦60°, FIG. 14(B) shows a case of 0°<α<30°, and FIG. 14(C) shows a case of α≠90°;

FIG. 15 is a perspective view of the resin product molded by the mold for in-mold coating according to the present invention;

FIG. 16 is a sectional view of the mold for in-mold coating according to the present invention;

FIG. 17 illustrates molding of a tongue;

FIG. 18 illustrates a recess;

FIG. 19 illustrates the in-mold coating;

FIG. 20 illustrates the in-mold coating;

FIG. 21 illustrates an operation of the tongue;

FIG. 22 illustrates various recesses and tongues, FIG. 22(A) shows a substantially trapezoidal recess, FIG. 22(B) shows a rectangular recess with a gradient, FIG. 22(C) shows an end shape of the tongue;

FIG. 23 is a configuration diagram of a device for carrying out an in-mold coating method according to the present invention;

FIG. 24 is a configuration diagram of a coating material supply device;

FIG. 25 illustrates a melted resin injection step;

FIG. 26 illustrates a first embodiment, FIG. 26(A) shows a fixed amount injection step, FIG. 26(B) shows a pressure maintaining injection step, and FIG. 26(C) shows a pressure waveform in the mold;

FIG. 27 illustrates a front surface of the resin molded product coated with the coating material;

FIG. 28 illustrates a second embodiment, FIG. 28(A) shows a fixed pressure injection step, FIG. 28(B) shows a pressure maintaining injection step, FIG. 28(C) shows a pressure waveform in a mold;

FIG. 29 illustrates a third embodiment, FIG. 29(A) shows a fixed amount injection step, FIG. 29(B) shows a pressure maintaining injection step, FIG. 29(C) shows a pressure waveform on the side of a coating material supply device; and

FIG. 30 illustrates a fourth embodiment, FIG. 30(A) shows a fixed pressure injection step, FIG. 30(B) shows a pressure maintaining injection step, FIG. 30(C) shows a pressure waveform on the side of a coating material supply device.

### DETAILED DESCRIPTION OF THE PREFERRED EMBODIMENTS

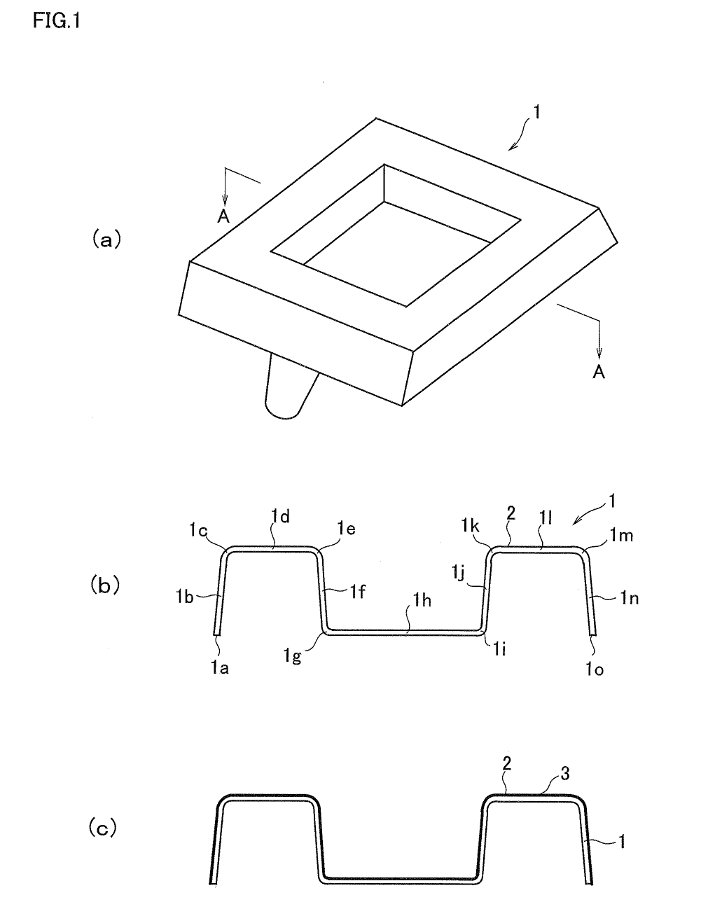

Now, embodiments of the present invention will be described with reference to the accompanying drawings. A resin product 1 subjected to in-mold coating has, for example, a box shape with a recessed shape in the middle as shown in FIG. 1(A). As shown in FIG. 1(B), from a section of the resin product 1, the resin product 1 includes an end 1a, a vertical wall portion 1b, a corner portion 1c, a lateral wall portion 1d, a corner portion 1e, a vertical wall portion 1f, a corner portion 1g, a lateral wall portion 1h, a corner portion 1i, a vertical wall portion 1j, a corner portion 1k, a lateral wall portion 1l, a corner portion 1m, a vertical wall portion 1n, and an end 1o. As shown in FIG. 1(C), a front surface 2 of the resin product 1 is coated with a coating material 3.

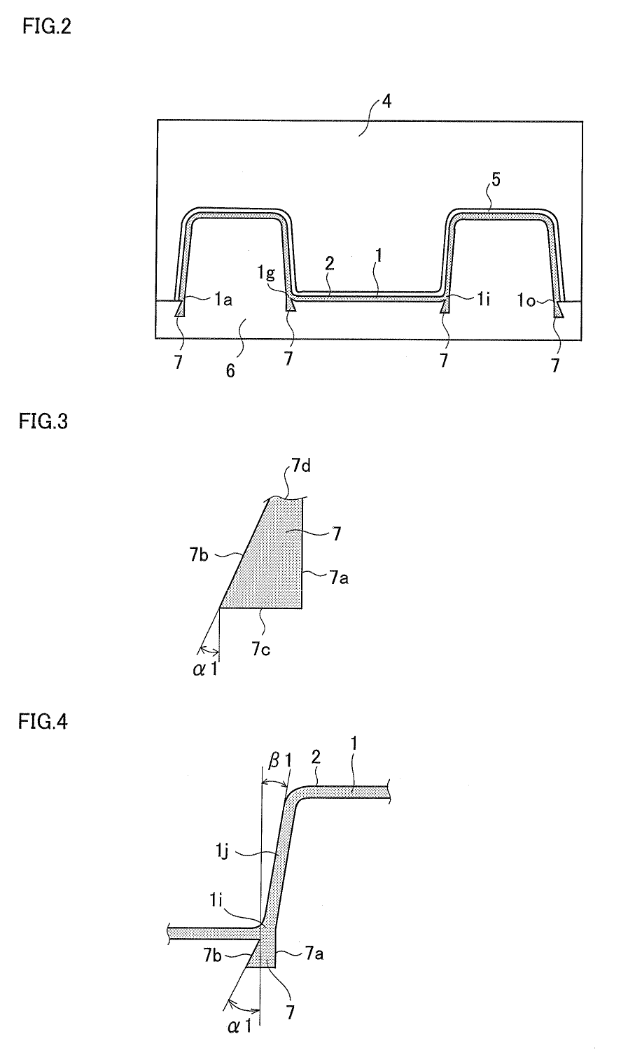

To perform in-mold coating of the resin product 1, as shown in FIG. 2, a gap 5 through which the coating material 3 flows needs to be formed between the front surface 2 of the injection molded resin product 1 and a cavity 4. Thus, a substantially rectangular parallelepiped anchor portion 7 connecting to each of the end 1a, the corner portion 1g, the corner portion 1i, and the end 1o of the resin product 1 in contact with a core 6 is molded on the side of the core 6.

As shown in FIG. 3, the anchor portion 7 is molded to be surrounded by a wall portion 7a provided in a mold opening direction, an inclined wall portion 7b provided to face the wall portion 7a at a predetermined angle α1, a bottom surface 7c, or the like. The anchor portion 7 is molded so that the bottom surface 7c is larger than a surface 7d connecting to the end 1a or 1o or the corner portion 1g or 1i, and only the inclined wall portion 7b has an undercut shape.

An angle α1 formed by the wall portion 7a and the inclined wall portion 7b is equal to or larger than an angle β1 formed by the wall portion 7a and the product surface 2 of the vertical wall portion 1j (α1≧β1) as shown in FIG. 4. The same applies to an angle β1 formed by the wall portion 7a and the product surface 2 of each of the other vertical wall portions 1b, 1f and 1n.

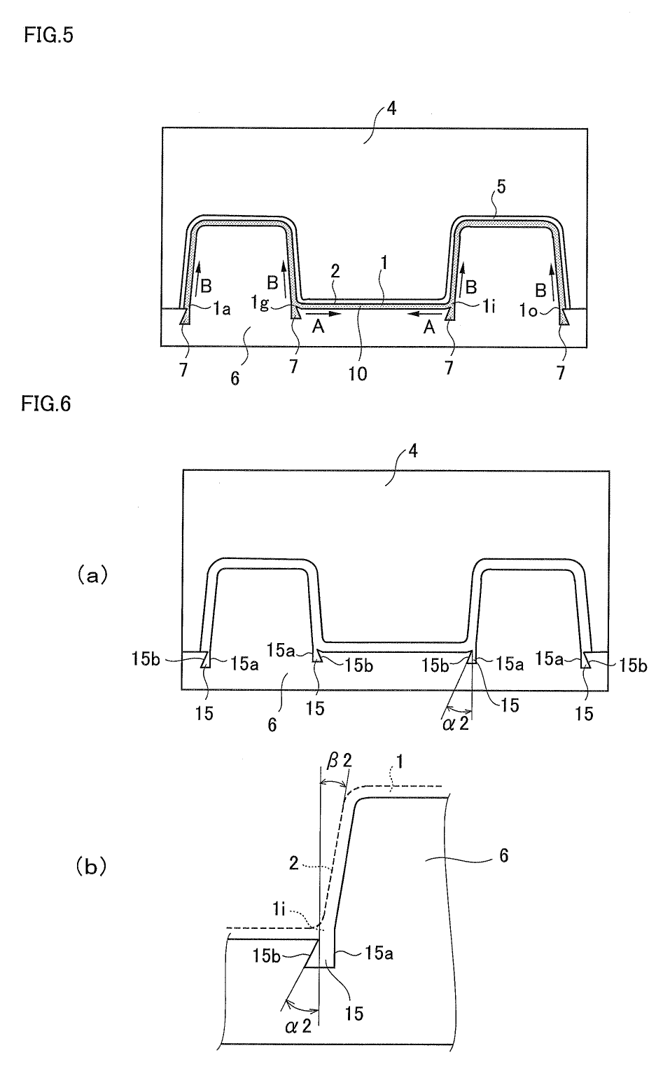

Providing the anchor portion 7 at each of the ends 1a and 1o and the corner portions 1g and 1i of the resin product 1 allows shrinkage of resin 10 in the arrow A direction to be restrained and also allows a restraining force to be obtained against deformation of the resin 10 due to shrinkage in the arrow B direction as shown in FIG. 5.

Further, the anchor portion 7 has the undercut shape, and thus can prevent behavior of the resin 10 toward the cavity 4 when the resin 10 shrinks, thereby ensuring the gap 5 through which the coating material 3 flows. Even in a region with shrinkage in two axial directions, the inclined surface of the inclined wall portion 7b can prevent behavior of the resin 10 toward the cavity 4, thereby ensuring the gap 5.

To form the anchor portion 7, in the mold for in-mold coating according to the present invention, a recess 15 having an a undercut shape and formed of a wall portion 15a provided in a mold opening direction from the side of the core 6 and an inclined wall portion 15b provided to face the wall portion 15a at a predetermined angle α2 is provided in the core 6 in each of regions corresponding to the ends 1a and 1o and the corner portions 1g and 1i of the resin product 1 as shown in FIG. 6(A).

The angle α2 formed by the wall portion 15a and the inclined wall portion 15b is desirably equal to or larger than an angle β2 formed by the wall portion 15a and the product surface 2 of the vertical wall portion 1j (α2≧β2) as shown in FIG. 6(B). The same applies to an angle β2 formed by the angle wall portion 15a and the product surface 2 of each of the other vertical wall portions 1b, 1f and 1n.

The anchor portion 7 having the undercut shape is molded by the recess 15 having the undercut shape. By the action of the anchor portion 7 described above, the gap 5 through which the coating material 3 flows is formed between the front surface 2 of the injection molded resin product 1 and the cavity 4. Further, the coating material 3 is supplied to the gap 5, and the front surface 2 of the resin product 1 is coated with the coating material 3.

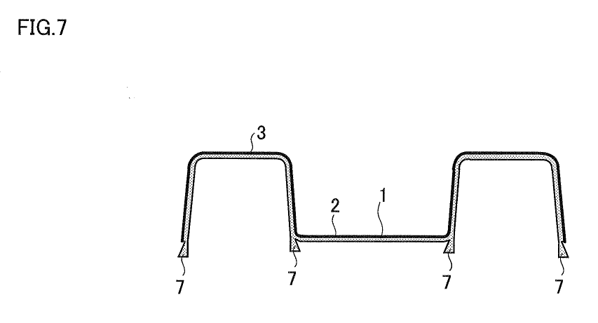

The resin product 1 with the front surface 2 coated with the coating material 3 is smoothly taken out of the mold by setting the angle α2 formed by the wall portion 15a and the inclined wall portion 15b to an appropriate value even if the anchor portion 7 having the undercut shape is molded as a part of the resin product 1. Then, as shown in FIG. 7, the resin product 1 with the front surface 2 coated with the coating material 3 is produced.

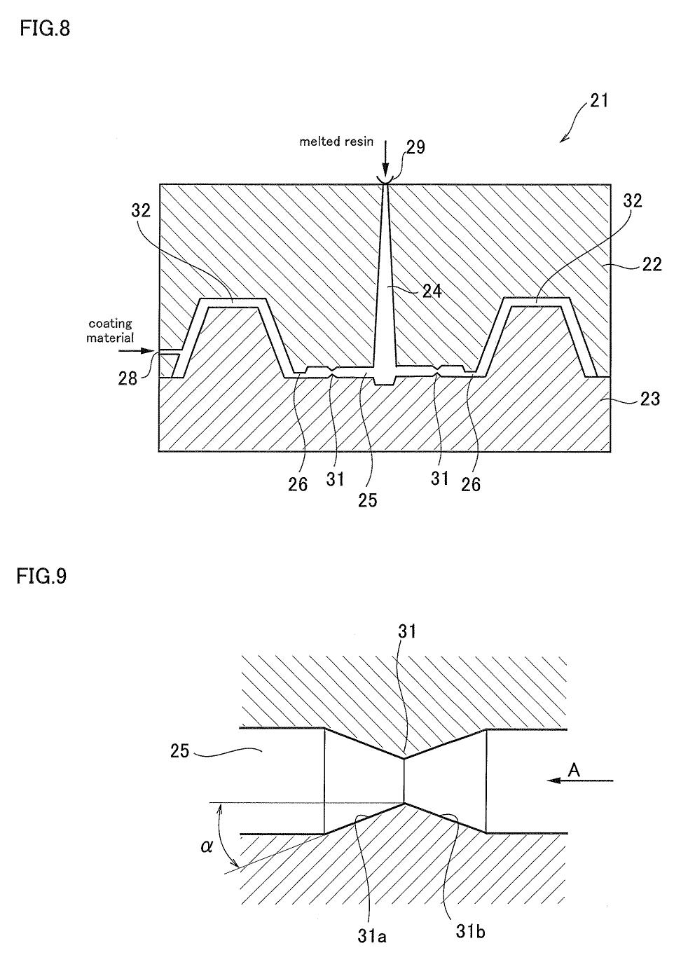

Next, as shown in FIG. 8, a mold for in-mold coating 21 according to the present invention is a mold for performing in-mold coating, and includes a fixed mold 22, a movable mold 23, a sprue 24, a runner 25, a gate 26, a coating material injection portion 28 that injects a coating material 27, or the like.

A protrusion 31 is provided to protrude in the runner 25 that is a passage of melted resin 30 supplied from a nozzle 29 of an injection molding machine, in the middle between the sprue 24 and the gate 26. The runner 25 may have any sectional shape including a rectangular, circular, or semi-circular sectional shape.

The protrusion 31 adheres to the shrinking resin 30 to form a seal portion with the coating material 27 without preventing the melted resin 30 from flowing into the runner 25. As shown in FIG. 9, the protrusion 31 forms an annular protruding shape protruding in the runner 25 with two continuous inclined surfaces 31a and 31b. An angle α formed by the inclined surface 31a and a flowing direction (arrow A direction) of the melted resin 30 is preferably 30°≦α≦60°.

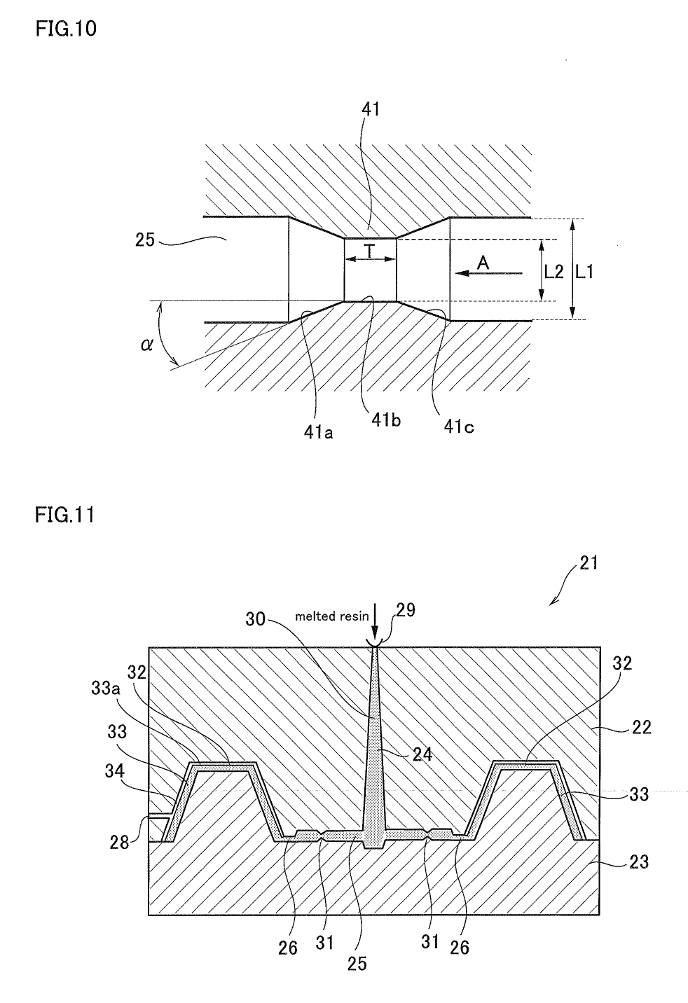

Instead of the protrusion 31, as shown in FIG. 10, an annular protrusion 41 protruding in the runner 25 may be formed by an inclined surface 41a, a parallel surface 41b, and an inclined surface 41c that are continuous with respect to the flow of the melted resin 30.

An angle α formed by the inclined surface 41a and the flowing direction (arrow A direction) of the melted resin 30, an inner diameter L1 of the runner 25, a minimum inner diameter L2 of the protrusion 41, and a length T of the parallel surface 41b are preferably 30°<≦α≦60°, L1≧1.05×L2, and T≧0 [mm]. The case of T=0 corresponds to the protrusion 31 shown in FIG. 9.

An operation of the mold for in-mold coating 21 thus configured according to the present invention will be described. As shown in FIG. 11, the mold for in-mold coating 21 forms a cavity 32 by the fixed mold 22 and the movable mold 23, and the melted resin 30 supplied from the nozzle 29 of the injection molding machine is injected into the cavity 32 via the sprue 24, the runner 25, and the gate 26 to mold a resin product 33.

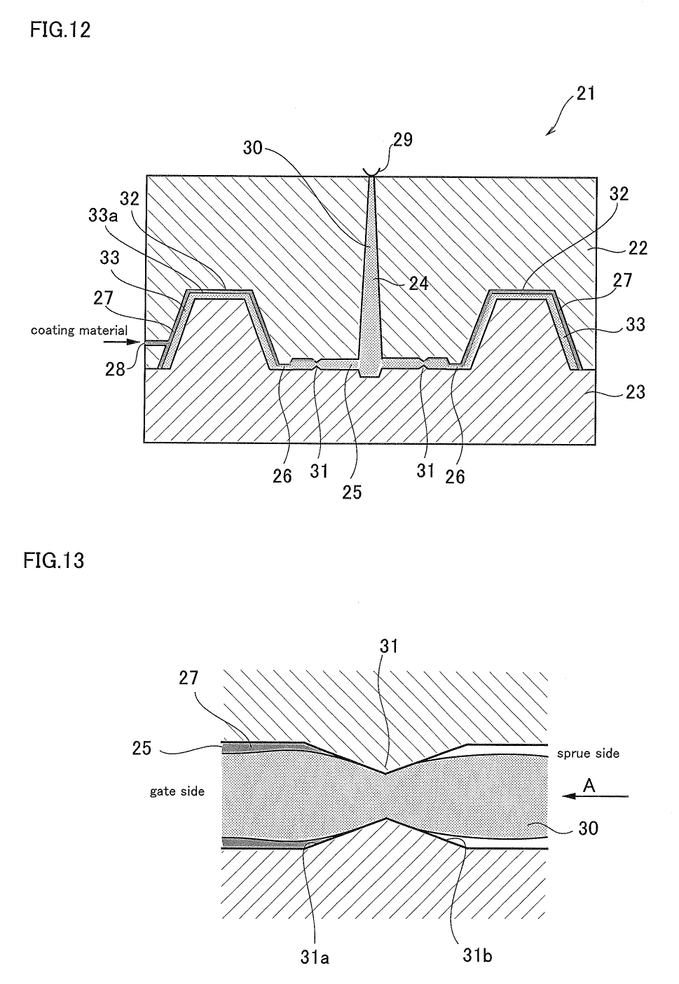

Then, in the mold for in-mold coating 21, after the resin product 33 is molded, the coating material 27 is poured from the coating material injection portion 28 into a gap 34 formed by the resin product 33 and the cavity 32, and a front surface (design surface) 33a of the resin product 33 is coated with the coating material 27 as shown in FIG. 12. At this time, the coating material 27 passes over the gap 34 formed by the resin product 33 and the cavity 32 and flows from the gate 26 toward the runner 25.

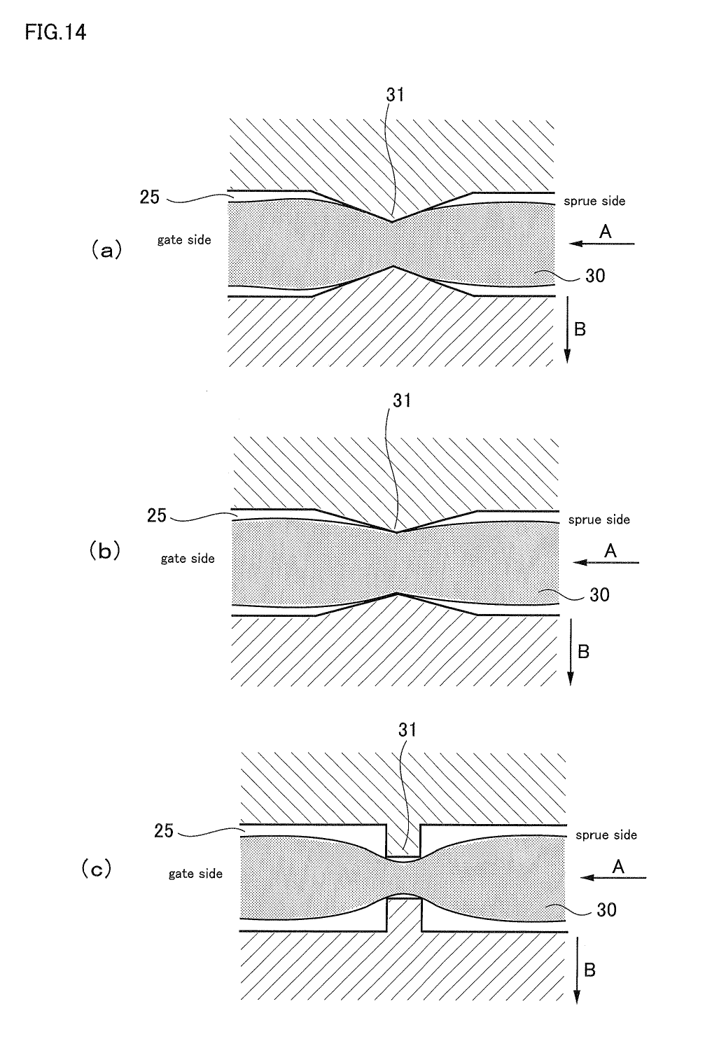

However, as shown in FIG. 13, since the protrusion 31 is held by a shrinkage force of the resin 30 to seal the coating material 27 having flown into the runner 25, the coating material 27 having flown from the gate 26 into the runner 25 does not pass over the protrusion 31 and flow into the sprue 24.

When the angle α is 30°≦α≦60°, as shown in FIG. 14(A), a pressing force (arrow B direction) against the mold 22 is larger than a force in the flowing direction (arrow A direction) of the resin 30 caused by shrinkage of the resin 30, and the protrusion 31 adheres to the resin 30, thereby preventing the coating material 27 from flowing into the sprue 24.

When the angle α is 0°<α<30°, as shown in FIG. 14(B), the force in the flowing direction (arrow A direction) of the resin 30 caused by shrinkage of the resin 30 becomes larger and the pressing force (arrow B direction) against the mold 22 becomes smaller, and thus the protrusion 31 does not firmly adhere to the resin 30, making it difficult to reliably prevent the coating material 27 from flowing into the sprue 24.

When the angle α is around 90°, as shown in FIG. 14(C), a contact surface area between the resin 30 and the protrusion 31 becomes smaller and the pressing force (arrow B direction) against the mold 22 becomes smaller, making it difficult to prevent the coating material 27 from flowing into the sprue 24.

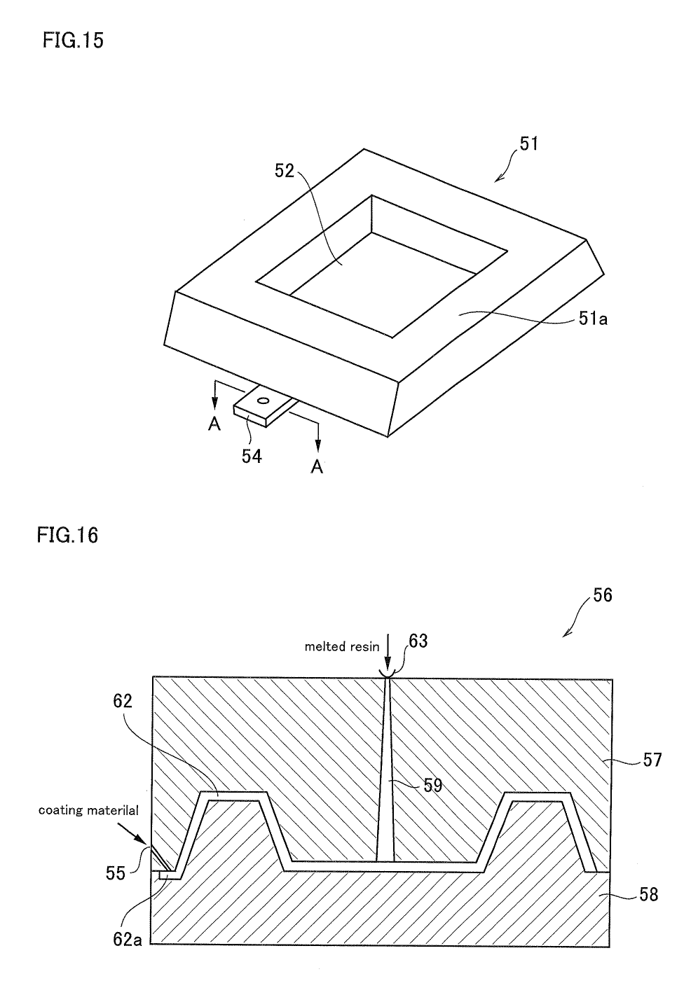

Next, a resin product 51 subjected to in-mold coating has, for example, a box shape with a recessed shape 52 in the middle as shown in FIG. 15. A front surface 51a of the resin product 51 is coated with a coating material 53. Reference numeral 54 denotes a tongue to which a coating material injection portion 55 for coating the front surface 51a of the resin product 51 with the coating material 53 is connected. Since the tongue 54 is not included in the resin product 51, the tongue 54 is removed after the front surface 51a of the resin product 51 is coated with the coating material 53.

As shown in FIG. 16, a mold for in-mold coating 56 according to the present invention is a mold for performing in-mold coating, and includes a mold 57 on a front surface side of a resin product, a mold 58 on a back surface side of the resin product, a sprue 59, the coating material injection portion 55 that injects the coating material 53, an unshown runner, a gate, or the like. The mold 57 on the front surface side of the resin product and the mold 58 on the back surface side of the resin product form a cavity 62 for molding the resin product 51. Reference numeral 63 denotes a nozzle of an injection molding machine that supplies melted resin 64 to the sprue 59.

As shown in FIG. 17, a recess 65 is provided in a peripheral edge of the mold 58 on the back surface side of the resin product that forms a cavity 62a facing the coating material injection portion 55. The tongue 54 molded by the recess 65 and the cavity 62a adheres to the mold 58 on the back surface side of the resin product and the mold 57 on the front surface side of the resin product to form a seal portion of the coating material 53 flowing out toward a back surface 51b of the resin product 51. The tongue 54 includes a plate-like portion 54a molded by the cavity 62a and a resin protrusion 54b molded by the recess 65. The tongue 54 in FIG. 17 is shown by a section taken along the line A-A in FIG. 15.

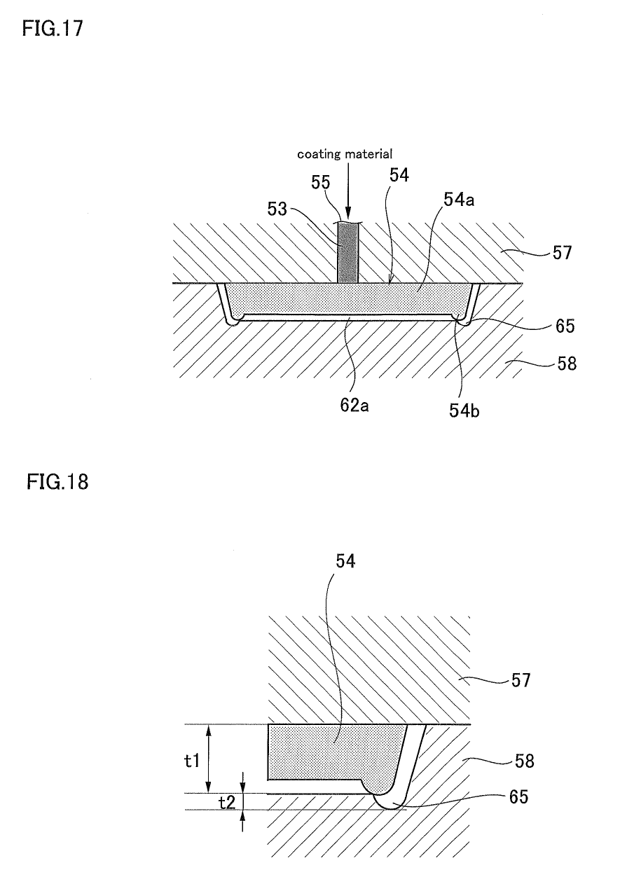

As shown in FIG. 18, the recess 65 provided in the peripheral edge of the mold 58 on the back surface side of the resin product preferably has a substantially semi-circular section, with a relationship between a depth t2 of the recess 65 and a depth t1 of the cavity 62a adjacent to the recess 65 and molding the plate-like portion 54a set to 0.01t1≦t2≦t1.

An operation of the mold for in-mold coating 56 thus configured according to the present invention will be described. As shown in FIG. 19, the mold for in-mold coating 56 forms the cavity 62 by the mold 57 on the front surface side of the resin product and the mold 58 on the back surface side of the resin product, and the melted resin 64 supplied from the nozzle 63 of the injection molding machine is injected into the cavity 62 via the sprue 59 to mold the resin product 51.

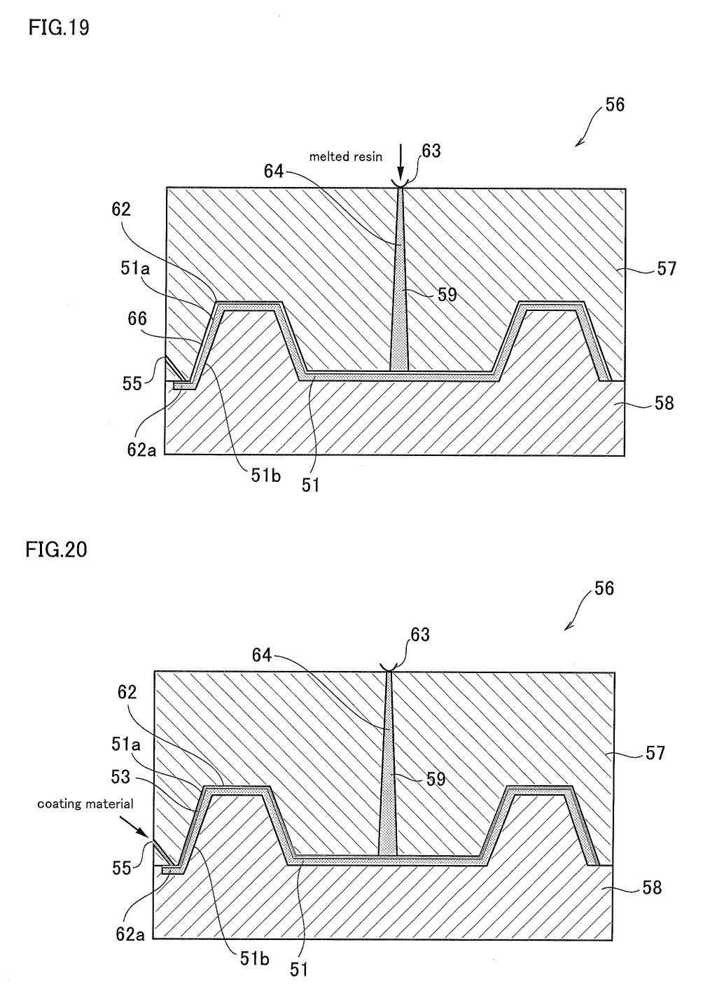

Then, in the mold for in-mold coating 56, after the resin product 51 is molded, the coating material 53 is poured from the coating material injection portion 55 into a gap 66 formed by the resin product 51 and the cavity 62, and the front surface (design surface) 51a of the resin product 51 is coated with the coating material 53 as shown in FIG. 20. At this time, the coating material 53 tries to flow toward the back surface 51b of the resin product 51.

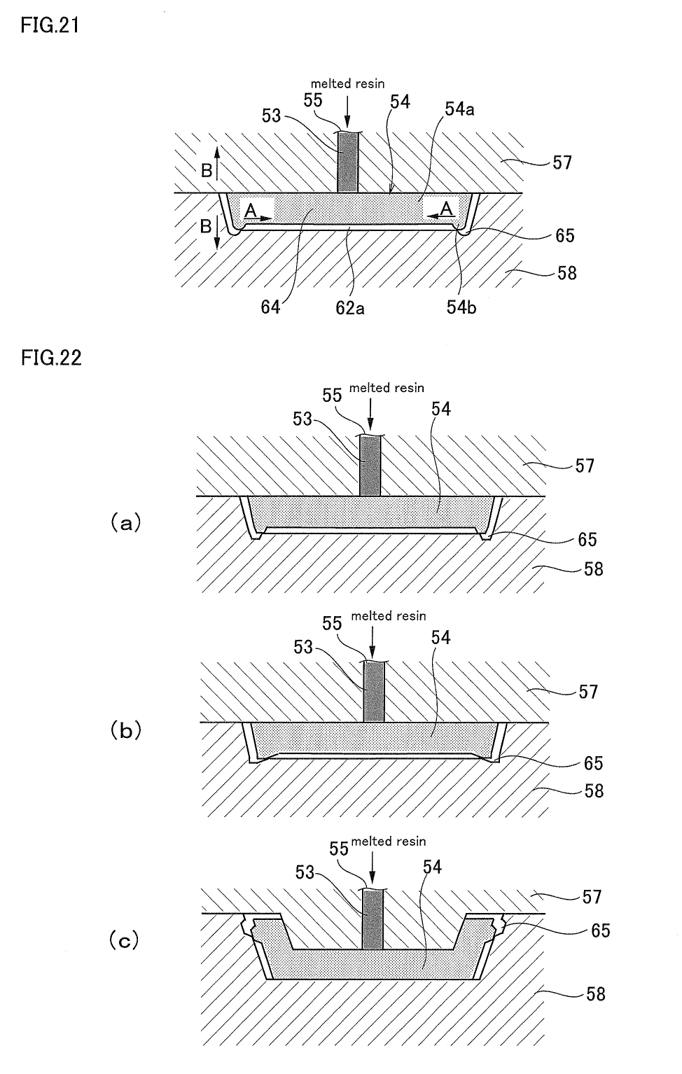

However, as shown in FIG. 21, the resin protrusion 54b molded by the recess 65 is removed from the recess 65 by shrinkage of the resin 64 in the arrow A direction and placed on the mold 58 on the back surface side of the resin product. Then, the plate-like portion 54a molded by the cavity 62a presses the mold 57 on the front surface side of the resin product in the arrow B direction. Thus, the tongue 54 formed of the plate-like portion 54a and the resin protrusion 54b adheres to the mold 57 on the front surface side of the resin product and the mold 58 on the back surface side of the resin product.

Such behavior of the resin protrusion 54b and the plate-like portion 54a causes the tongue 54 to adhere to the mold 57 on the front surface side of the resin product and the mold 58 on the back surface side of the resin product. Thus, even around the coating material injection portion 55 with high injection pressure, the coating material 53 can be prevented from flowing out toward the back surface 51b of the resin product 51, and there is no shortage of the coating material 53 at an end portion of the resin product 51.

Even if injection pressure of the coating material 53 reduces an adhesive force of the coating material injection portion (between the plate-like portion 54a and the mold 57 on the front surface side of the resin product), an adhesive force between the resin protrusion 54b and the mold 58 on the back surface side of the resin product in the arrow B direction is further increased by the injection pressure of the coating material 53, thereby reliably preventing the coating material 53 from flowing out toward the back surface 51b of the resin product 51.

The recess 65 may have a substantially semi-circular section as shown in FIG. 18, a substantially trapezoidal section as shown in FIG. 22(A), or a rectangular section with a gradient as shown in FIG. 22(B). The end shape of the tongue 54 is not limited as shown in FIG. 22(C).

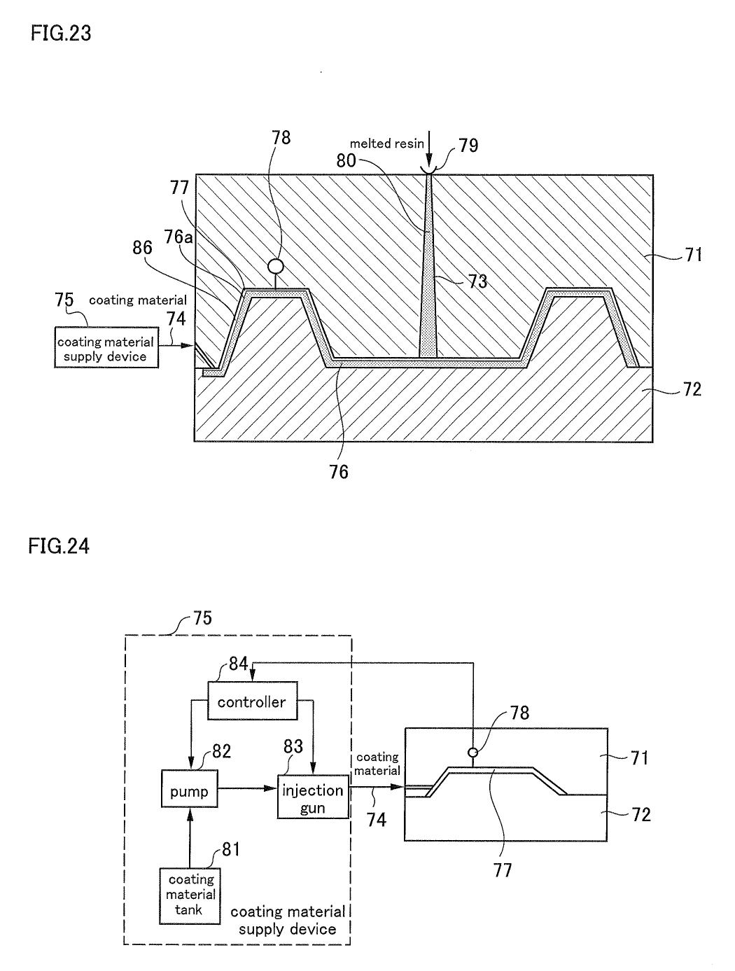

Next, a device for carrying out the in-mold coating method according to the present invention includes, as shown in FIG. 23, a fixed mold 71, a movable mold 72, a sprue 73, a coating material supply device 75 that injects a coating material 74 into the molds 71 and 72, or the like. The fixed mold 71 and the movable mold 72 form a cavity 77 for molding a resin molded product 76. A pressure sensor 78 that detects pressure in the cavity 77 is provided in the fixed mold 71. Reference numeral 79 denotes a nozzle of an injection molding machine that supplies melted resin 80 to the sprue 73.

As shown in FIG. 24, the coating material supply device 75 includes a coating material tank 81, a pump 82, an injection gun 83, a controller 84, or the like. The coating material supply device 75 can supply the coating material 74 stored in the coating material tank 81 in a desired amount at desired pressure to the cavity 77. The coating material supply device 75 may feed back a detection signal of the pressure sensor 78, and supply the coating material 74 to the cavity 77 until the pressure in the cavity 77 reaches a predetermined value or within a desired range.

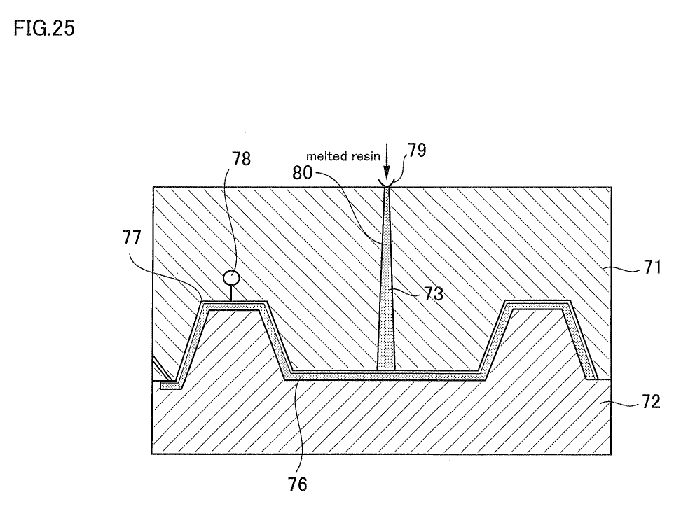

In a first embodiment of an in-mold coating method according to the present invention carried out by the device configured as described above, as shown in FIG. 25, the cavity 77 is formed by the fixed mold 71 and the movable mold 72, the melted resin 80 supplied from the nozzle 79 of the injection molding machine is injected into the cavity 77 via the sprue 73, and the resin molded product 76 is molded (melted resin injection step).

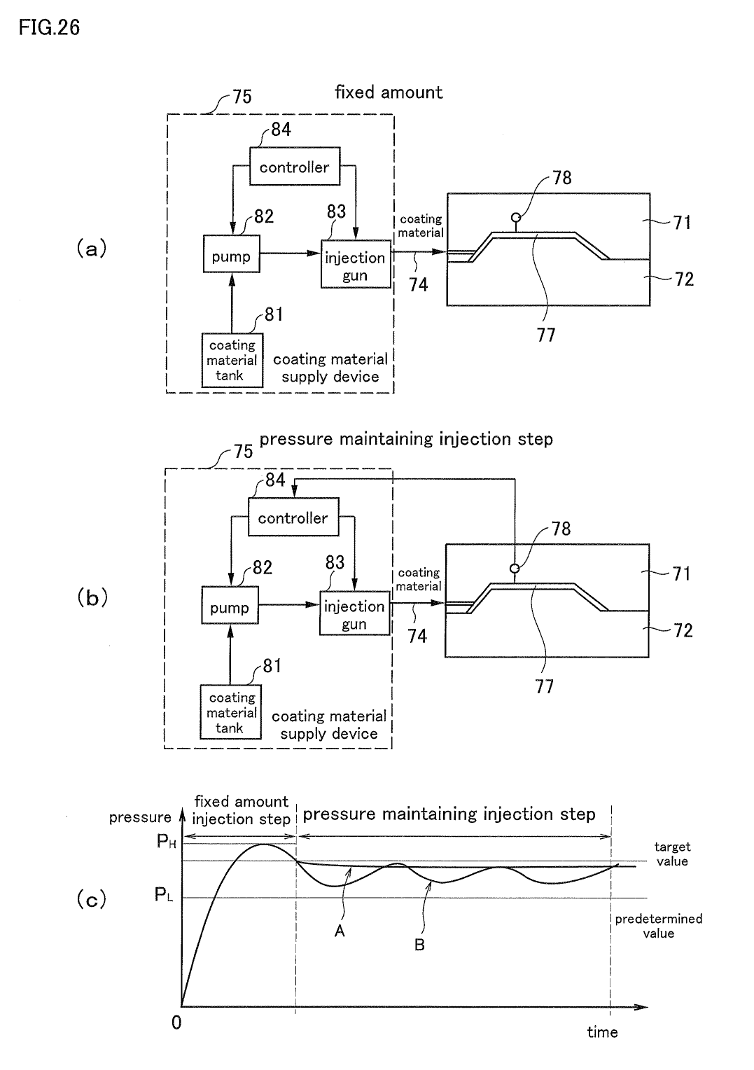

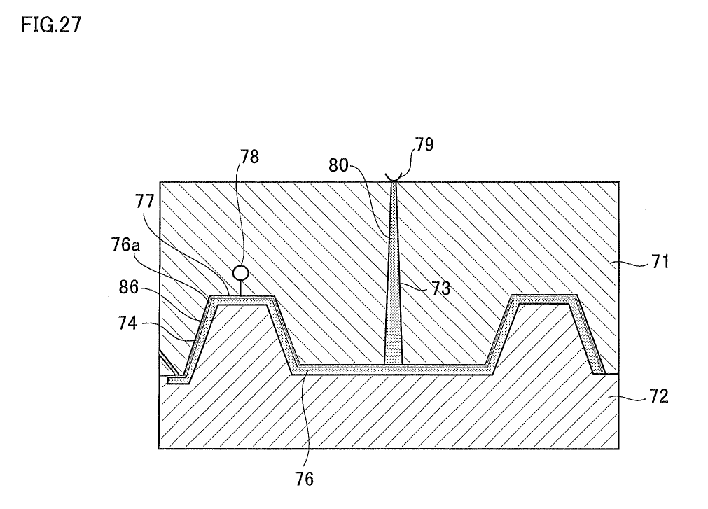

Then, at the time when a skin layer is formed on the resin molded product 76 in the melted resin injection step, as shown in FIG. 26(A), the coating material supply device 75 drives the pump 82 to inject a predetermined amount of coating material 74 from the injection gun 83 into a gap 86 formed by the resin molded product 76 and the fixed mold 71 (fixed amount injection step).

Then, as shown in FIG. 26(B), the coating material supply device 75 sets maximum pressure P_{H} in the cavity 77 and a target value in the fixed amount injection step, and drives the pump 82 so that the pressure in the cavity 77 is maintained at a predetermined value P_{L} or more to inject the coating material 74 from the injection gun 83 into the cavity 77 (pressure maintaining injection step).

As shown in FIG. 26(C), the pressure in the cavity 77 is controlled by the coating material supply device 75 in the fixed amount injection step and the pressure maintaining injection step. In the pressure maintaining injection step, the pressure in the cavity 77 is controlled to be a target value (arrow A) or a value between the target value and the predetermined value P_{L} (arrow B). The predetermined value P_{L} is preferably 0.05 MPa≦P_{L}. Then, as shown in FIG. 27, a front surface (design surface) 76a of the resin molded product 76 is coated with the coating material 74.

In a second embodiment of an in-mold coating method according to the present invention, the cavity 77 is formed by the fixed mold 71 and the movable mold 72, the melted resin 80 supplied from the nozzle 79 of the injection molding machine is injected into the cavity 77 via the sprue 73, and the resin molded product 76 is molded (melted resin injection step) like the first embodiment shown in FIG. 25.

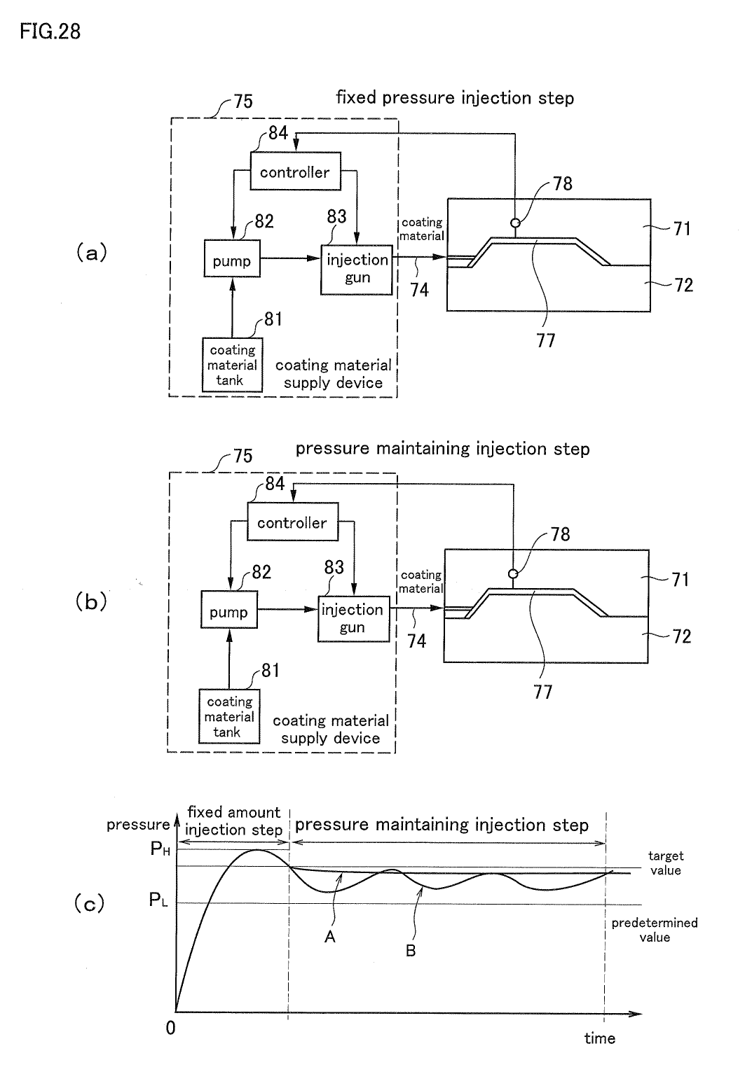

Then, at the time when a skin layer is formed on the resin molded product 76 in the melted resin injection step, as shown in FIG. 28(A), the coating material supply device 75 drives the pump 82 to inject the coating material 74 from the injection gun 83 into the gap 86 formed by the resin molded product 76 and the fixed mold 71 and into the cavity 77 until the pressure in the cavity 77 reaches a set pressure (fixed pressure injection step).

Then, as shown in FIG. 28(B), the coating material supply device 75 sets set pressure P_{H} and a target value in the fixed pressure injection step, and drives the pump 82 so that the pressure in the cavity 77 is maintained at a predetermined value P_{L} or more to inject the coating material 74 from the injection gun 83 into the cavity 77 (pressure maintaining injection step).

As shown in FIG. 28(C), the pressure in the cavity 77 is controlled by the coating material supply device 75 in the fixed pressure injection step and the pressure maintaining injection step. In the pressure maintaining injection step, the pressure in the cavity 77 is controlled to be a target value (arrow A) or a value between the target value and the predetermined value P_{L} (arrow B). The predetermined value P_{L} is preferably 0.05 MPa≦P_{L}. Then, as shown in FIG. 27, the front surface (design surface) 76a of the resin molded product 76 is coated with the coating material 74.

In the above-described first and second embodiments shown in FIGS. 23 and 24, the pressure in the cavity 77 is detected and fed back to the controller 84 in the coating material supply device 75, but pressure on the side of the coating material supply device 75, for example, pressure of the coating material 74 on an input side of the injection gun 83 may be detected and fed back to the controller 84.

In a third embodiment of an in-mold coating method according to the present invention, the cavity 77 is formed by the fixed mold 71 and the movable mold 72, the melted resin 80 supplied from the nozzle 79 of the injection molding machine is injected into the cavity 77 via the sprue 73, and the resin molded product 76 is molded (melted resin injection step) like the first embodiment shown in FIG. 25.

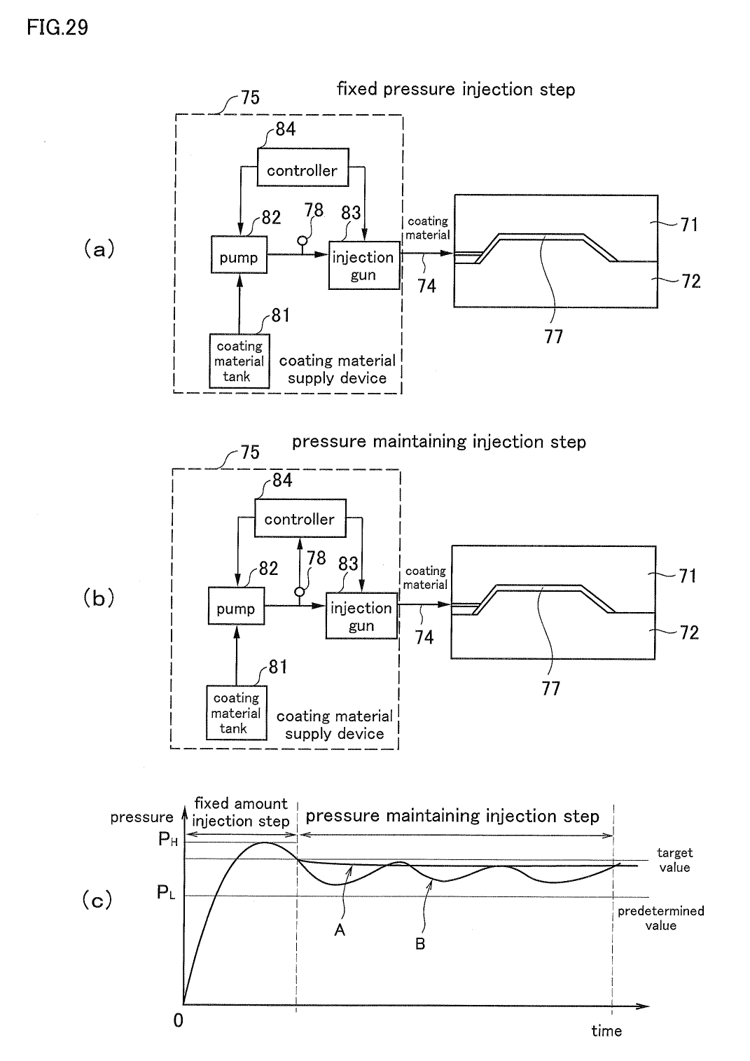

Then, at the time when a skin layer is formed on the resin molded product 76 in the melted resin injection step, as shown in FIG. 29(A), the coating material supply device 75 drives the pump 82 to inject a predetermined amount of coating material 74 from the injection gun 83 into the gap 86 formed by the resin molded product 76 and the fixed mold 71 (fixed amount injection step).

Then, as shown in FIG. 29(B), the coating material supply device 75 sets maximum pressure P_{H} on the input side of the injection gun 83 and a target value in the fixed amount injection step, and drives the pump 82 so that the pressure on the input side of the injection gun 83 is maintained at a predetermined value P_{L} or more to inject the coating material 74 from the injection gun 83 into the cavity 77 (pressure maintaining injection step).

As shown in FIG. 29(C), the pressure on the input side of the injection gun 83 is controlled by the coating material supply device 75 in the fixed amount injection step and the pressure maintaining injection step. In the pressure maintaining injection step, the pressure on the input side of the injection gun 83 is controlled to be a target value (arrow A) or a value between the target value and the predetermined value P_{L} (arrow B). The predetermined value P_{L} is preferably 0.05 MPa≦P_{L}. Then, as shown in FIG. 27, the front surface (design surface) 76a of the resin molded product 76 is coated with the coating material 74.

In a fourth embodiment of an in-mold coating method according to the present invention, the cavity 77 is formed by the fixed mold 71 and the movable mold 72, the melted resin 80 supplied from the nozzle 79 of the injection molding machine is injected into the cavity 77 via the sprue 73, and the resin molded product 76 is molded (melted resin injection step) like the first embodiment shown in FIG. 25.

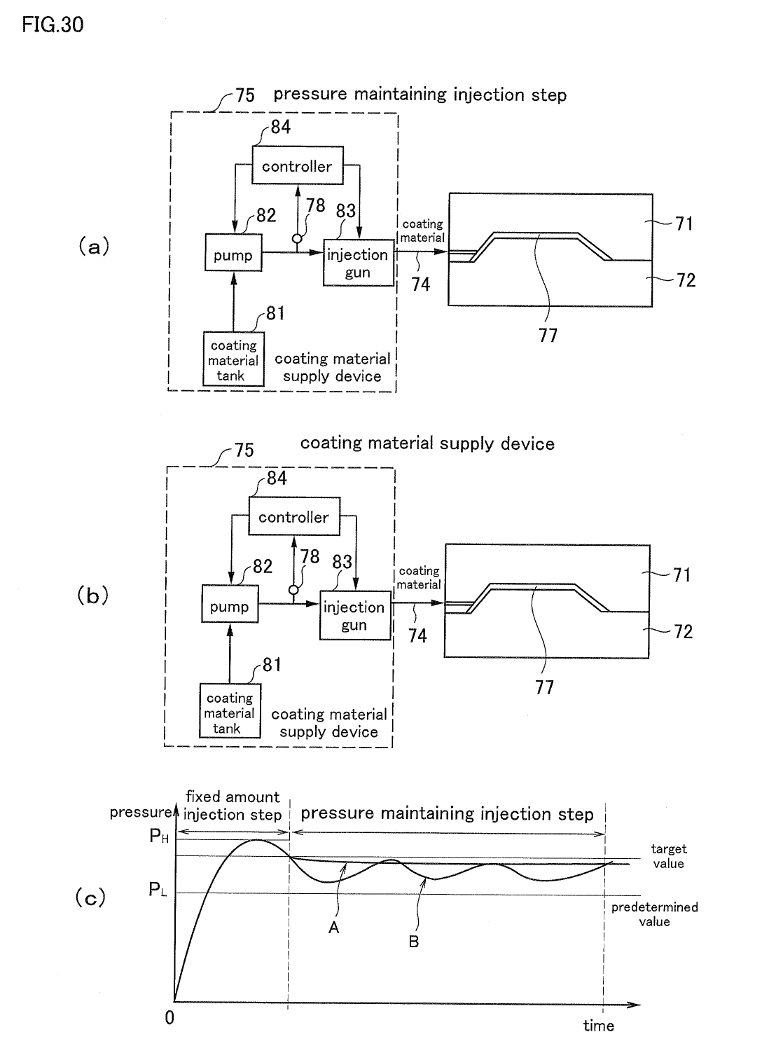

Then, at the time when a skin layer is formed on the resin molded product 76 in the melted resin injection step, as shown in FIG. 30(A), the coating material supply device 75 drives the pump 82 to inject the coating material 74 from the injection gun 83 into the gap 86 formed by the resin molded product 76 and the fixed mold 71 and into the cavity 77 until the pressure on the input side of the injection gun reaches a set pressure (fixed pressure injection step).

Then, as shown in FIG. 30(B), the coating material supply device 75 sets set pressure P_{H} and a target value in the fixed pressure injection step, and drives the pump 82 so that the pressure on the input side of the injection gun 83 is maintained at a predetermined value P_{L} or more to inject the coating material 74 from the injection gun 83 into the cavity 77 (pressure maintaining injection step).

As shown in FIG. 30(C), the pressure on the input side of the injection gun 83 is controlled by the coating material supply device 75 in the fixed pressure injection step and the pressure maintaining injection step. In the pressure maintaining injection step, the pressure on the input side of the injection gun 83 is controlled to be a target value (arrow A) or a value between the target value and the predetermined value P_{L} (arrow B). The predetermined value P_{L} is preferably 0.05 MPa≦P_{L}. Then, as shown in FIG. 27, the front surface (design surface) 76a of the resin molded product 76 is coated with the coating material 74.

Either the pressure in the mold (in the cavity 77) or the pressure on the side of the coating material supply device 75 may be detected in injecting the coating material 74 as described above, but the pressure in the mold (in the cavity 77) is desirably detected.

According to the present invention, the mold for in-mold coating can be provided that can ensure the gap through which the coating material flows between the resin product and the cavity to fill the coating material, and obtain a sufficient film thickness on the front surface of the resin product in performing in-mold coating. Also, the mold for in-mold coating can be provided that can prevent the coating material from flowing over the runner into the sprue, and can be easily machined to reduce costs. Further, the mold for in-mold coating can be provided that can prevent the coating material from flowing out toward the back surface of the resin product, and can be easily machined to reduce costs.

Further, the in-mold coating method can be provided that can improve adherence between the coating material and the resin molded product without any special facility and mold, and eliminate a flaw such as a sink and significantly improve quality, and an expanded use of the method is expected.

What is claimed is:

1. A mold for in-mold coating comprising an undercut-shaped recess formed of a wall portion provided in a mold opening direction and an inclined wall portion provided to face the wall portion at a predetermined angle in a region corresponding to an end or a corner portion of a product.

2. The mold for in-mold coating according to claim 1, wherein an angle α2 formed by the wall portion and the inclined wall portion is equal to or larger than an angle β2 formed by the wall portion and a product surface of a vertical wall (α2≧β2).

3. A mold for in-mold coating in which a cavity is formed by a fixed mold and a movable mold, melted resin is injected into the cavity to mold a resin product, and the resin product is coated,
wherein a protrusion is provided on a runner through which the melted resin passes, and shrinking resin adheres to the protrusion to form a seal portion.

4. The mold for in-mold coating according to claim 3, wherein the protrusion forms a protruding shape with two continuous inclined surfaces, and an angle α formed by the inclined surface and a flowing direction of the melted resin is 30°≦α≦60°.

5. A mold for in-mold coating in which a cavity is formed by a mold on a front surface side of a resin product and a mold on a back surface side of the resin product, melted resin is injected into the cavity to mold the resin product, and a front surface of the resin product is coated with a coating material,
wherein a recess is provided in a peripheral edge of the mold on the back surface side of the resin product that forms the cavity facing an injection portion of the coating material, and resin that is molded by the recess and the cavity and shrinks adheres to the mold on the back surface side of the resin product and the mold on the front surface side of the resin product to form a seal portion of the coating material flowing out toward the back surface of the resin product.

6. The mold for in-mold coating according to claim 5, wherein a relationship between a depth t2 of the recess and a depth t1 of the cavity adjacent to the recess is 0.01t1≦t2≦t1.

7. An in-mold coating method for injecting a coating material into a mold and coating a front surface of a resin molded product, comprising:
an injection step of injecting the coating material into the mold; and
a pressure maintaining injection step of injecting the coating material into the mold so that pressure in the mold obtained in the injection step is maintained at a predetermined value or more.

8. The in-mold coating method according to claim 7, wherein the injection step is a fixed amount injection step of injecting a predetermined amount of coating material into the mold.

9. The in-mold coating method according to claim 7, wherein the injection step is a fixed pressure injection step of injecting the coating material into the mold until pressure in the mold reaches a set pressure.

10. An in-mold coating method for injecting a coating material into a mold and coating a front surface of a resin molded product, comprising:
an injection step of injecting the coating material into the mold; and
a pressure maintaining injection step of injecting the coating material into the mold so that injection pressure of a coating material supply device obtained in the injection, step is maintained at a predetermined value or more.

11. The in-mold coating method according to claim 10, wherein the injection step is a fixed amount injection step of injecting a predetermined amount of coating material into the mold.

12. The in-mold coating method according to claim 10, wherein the injection step is a fixed pressure injection step of injecting the coating material into the mold until injection pressure of the coating material supply device reaches a set pressure.
